(19) United States
(12) Patent Application Publication
(10) Pub. No.: US 2004/0160413 A1
(43) Pub. Date: Aug. 19, 2004

(54) Information processing apparatus

(75) Inventors: Hiroki Tamai, Kanagawa (JP); Mikio Sakemoto, Saitama (JP); Tetsuji Ando, Nagano (JP); Kenichi Agata, Tokyo (JP); Hisaya Miyashita, Kanagawa (JP); Naohiko Otake, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/772,262

(22) Filed: Feb. 6, 2004

(30) Foreign Application Priority Data
Feb. 13, 2003 (JP) 2003-035344

(51) Int. Cl. G09G 5/00

(52) U.S. Cl. 345/156

(57) ABSTRACT

An information processing apparatus includes a display, a pointing device for moving a pointer appearing on the display in a desired direction, and a plurality of cursor keys for moving a cursor appearing on the display in predetermined directions, the cursor keys being arranged near the pointing device.

### BACKGROUND OF THE INVENTION

1. Field of the Invention

The present invention relates to information processing apparatuses, and more specifically relates to a technical field of improving the user-friendliness in the operation of an information processing apparatus.

2. Description of the Related Art

Information processing apparatuses such as personal computers and personal digital assistants (PDAs) which include a display and a keyboard having a plurality of operation keys (for example, a key for switching between uppercase and lowercase characters, keys for inputting characters, etc.) are known in the art. In such an information processing apparatus, a cursor which indicates the position where a character input through the keyboard is typed is shown on the display and cursor keys are provided for moving the cursor one character or one line at a time.

In addition, the information processing apparatus shows visual operation objects, for example, visual buttons at desired positions on the display. A pointer for selecting an object to be operated from among the operation objects is also shown on the display, and a pointing device is provided for moving the pointer in a desired direction.

For example, a stick device having a stick-shaped projection with which the pointer is moved in a desired direction by applying a force with a finger, a pad device called an operation pad with which the pointer is moved in a desired direction by sliding a finger along the surface of the pad device, a left button which is operated for executing a function corresponding to an item selected from a menu or the like by the pointer, and a right button which is operated for displaying a sub menu (pop-up menu) at the position of the cursor are known as the pointing device.

In some information processing apparatuses, the pointing device is placed at the back right corner of a housing on which the keyboard is provided (refer to, for example, Page 3 and FIG. 1 of Japanese Unexamined Patent Application Publication No. 11-175236).

However, in the above-described known image forming apparatuses, the cursor keys for moving the cursor shown on the display are placed separately from the pointing device for moving the pointer. More specifically, four cursor keys with which the cursor shown on the display is moved up, down, left, and right are arranged at the front of the housing along with other operation keys and the pointing device with which the pointer shown on the display is moved in a desired direction is placed at the back of the housing.

Although the cursor keys and the pointing device are used for operating different objects, i.e., the cursor and the pointer, they also have a function to move the same object. In addition, the cursor keys and the pointing device are both used frequently and are often used one after the other. Accordingly, the user must move a hand between the cursor keys and the pointing device to use the cursor keys and the pointing device one after the other and there is a problem in that the operability is poor.

On the other hand, information processing apparatuses which can be used as portable devices have recently become popular. In such an information processing apparatus, the user must move a hand from the position at which it is grabbing the information processing apparatus to operate the cursor keys or the pointing device and the information processing apparatus is particularly user-unfriendly.

### SUMMARY OF THE INVENTION

In view of the above-described problems, an object of the present invention is to improve the user-friendliness in the operation of an information processing apparatus.

In order to attain this object, an information processing apparatus according to the present invention includes a display, a pointing device for moving a pointer appearing on the display in a desired direction, and a plurality of cursor keys for moving a cursor appearing on the display in predetermined directions, the cursor keys being arranged near the pointing device.

In the information processing apparatus according to the present invention, the cursor keys and the pointing device can be operated without moving a hand each time they are used. Thus, the operability can be improved.

In particular, in the case in which the information processing apparatus is used as a portable device, the pointing device and the cursor keys can be operated while grabbing the information processing apparatus with both hands. Thus, the user-friendliness can be improved.

In the information processing apparatus according to the present invention, the cursor keys may be arranged along the periphery of the pointing device such that the pointing device is at the center of the cursor keys. In such a case, the cursor keys can be positioned in correspondence with the directions in which the cursor is moved. Accordingly, misoperation can be prevented and the operability can be improved.

In addition, the information processing apparatus according to the present invention may further include a display unit having a display housing on which the display is provided, a main unit provided with a keyboard having a plurality of operation keys, and a hinge unit which connects the display unit and the main unit such that the display unit can pivot to open and close the keyboard. The hinge unit includes a hinge barrel and hinge pins disposed in the hinge barrel, and the pointing device and the cursor keys are positioned near one end of the information processing apparatus along the axis of the hinge pins in an area between the display unit and the keyboard. Accordingly, in the case in which the information processing apparatus is used as a portable device, the pointing device and the cursor keys can be operated with a hand while grabbing the information processing apparatus with that hand. Thus, the user-friendliness of the information processing apparatus when it is used as a portable device can be improved.

In addition, the information processing apparatus according to the present invention may further include a confirmation button for confirming a selected or input item, the confirmation button being positioned near the pointing device or the cursor keys. In such a case, the operability and the user-friendliness can be further improved.

### BRIEF DESCRIPTION OF THE DRAWINGS

FIG. 1 is a perspective view of an information processing apparatus according to an embodiment of the present invention in the state in which a display unit is opened;

FIG. 2 is a perspective view of the information processing apparatus in the state in which the display unit is closed;

FIG. 3 is a back view of the information processing apparatus in the state in which the display unit is closed;

FIG. 4 is a plan view of a main unit of the information processing apparatus;

FIG. 5 is a perspective view showing an example of the manner in which the information processing apparatus is used as a portable device;

FIG. 6 is a perspective view showing another example of the manner in which the information processing apparatus is used as a portable device;

FIG. 7 is a diagram showing the state in which an auxiliary input software program is activated and an input screen is displayed;

FIG. 8 is a diagram showing the state in which a software program for inputting characters is activated and a character-input screen is displayed;

FIG. 9 is a diagram showing the state in which a character input through auxiliary input keys and candidate words are shown on the input screen after the state shown in FIG. 8;

FIG. 10 is a diagram showing the state in which a desired candidate word is selected after the state shown in FIG. 9;

FIG. 11 is a diagram showing the state in which the selected candidate word is typed onto the character-input screen after the state shown in FIG. 10;

FIG. 12 is a diagram showing the state in which a character input through the auxiliary input keys and candidate words are shown on the input screen after the state shown in FIG. 11;

FIG. 13 is a diagram showing the state in which the selected candidate word is typed onto the character-input screen after the state shown in FIG. 12;

FIG. 14 is a diagram showing the state in which a character input through the auxiliary input keys and candidate words are shown on the input screen after the state shown in FIG. 13; and

FIG. 15 is a diagram showing the state in which the selected candidate word is typed onto the character-input screen after the state shown in FIG. 14.

### DESCRIPTION OF THE PREFERRED EMBODIMENT

An embodiment of the present invention will be described below with reference to the accompanying drawings. In the embodiment described below, the present invention is applied to an information processing apparatus (personal computer) which can be used as a portable device.

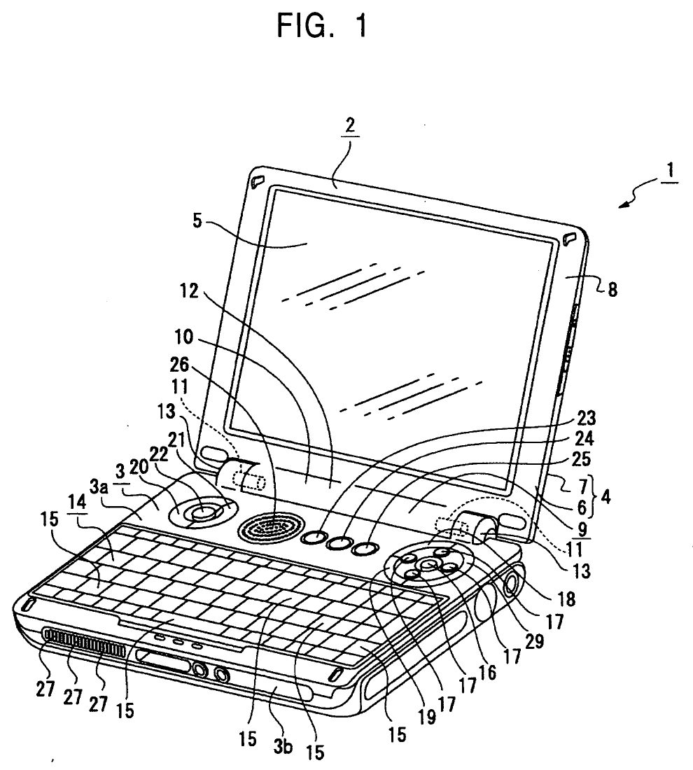

With reference to FIGS. 1 to 3, an information processing apparatus 1 includes a display unit 2 and a main unit 3.

The display unit 2 includes a display housing 4 and a display 5 provided on the display housing 4.

The display housing 4 is constructed by combining a rectangular, frame-shaped front panel 6 and a rectangular, shallow-box-shaped rear panel 7 which is open on the side facing the front panel 6, and is provided with a frame portion 8 on the periphery thereof.

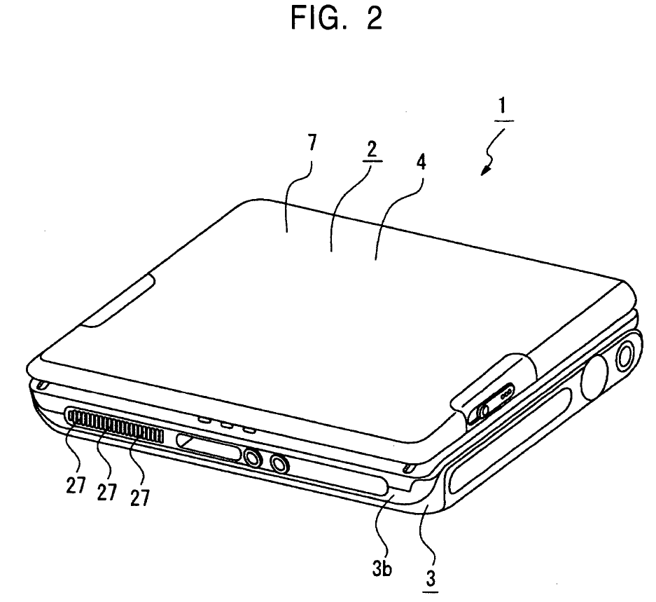

The display unit 2 can pivot around a hinge 9 which extends along the back edge of the main unit 3. When the information processing apparatus 1 is not used, the display unit 2 is at a position where the display unit 2 covers a keyboard provided on the main unit 3, as shown in FIG. 2.

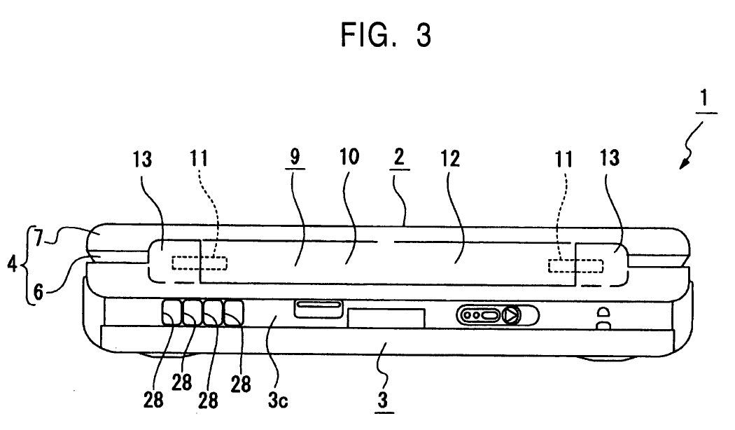

As shown in FIGS. 1 and 3, the hinge 9 includes a hinge barrel 10 and hinge pins 11 disposed in the hinge barrel 10, and the hinge barrel 10 includes a central portion 12 which projects from the display housing 4 and which is formed integrally with the display housing 4 and end portions 13 which project from the back edge of the main unit 3 and which are formed integrally with the external housing of the main unit 3.

As shown in FIGS. 1 and 3, the hinge pins 11 are placed between the central portion 12 and the end portions 13 of the hinge barrel 10 so as to connect the central portion 12 and the end portions 13 to each other.

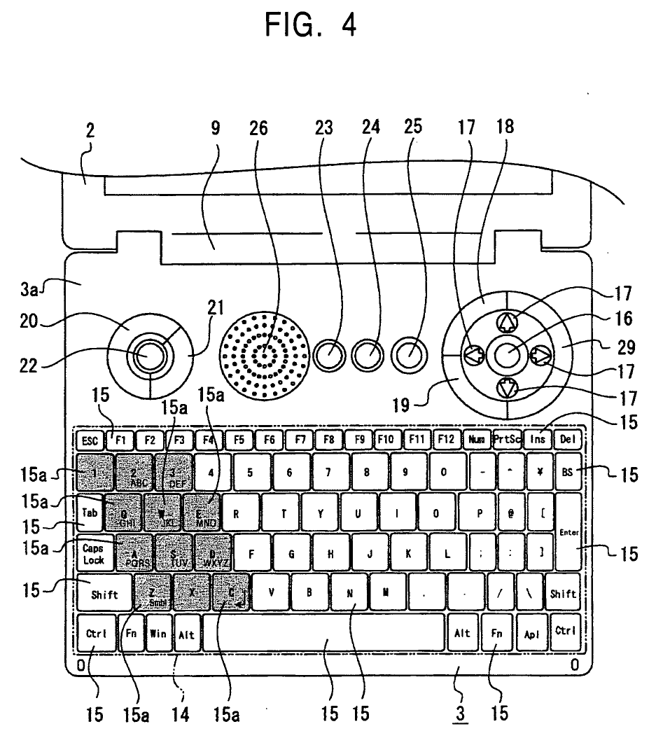

As shown in FIGS. 1 and 4, a keyboard 14 which is long in the horizontal direction is provided on the top surface 3a of the main unit 3 in an area excluding the back area. The keyboard 14 has a plurality of operation keys 15, and the main unit 3 contains a processor, such as a central processing unit (CPU), which performs processes based on signals input by operating the operation keys 15 on the keyboard 14.

As shown in FIG. 4, various kinds of keys are provided as the operation keys 15.

More specifically, an escape key for returning to the state before the last operation and function keys (F1 to F12) for executing predetermined functions are arranged in the backmost row, that is, the first row.

In addition, input keys for inputting predetermined numbers and characters are arranged in the second to fifth rows from the back and an enter key for confirming the inputs, etc., is arranged such that it extends over the third and fourth rows from the back.

In addition, control keys and alternate keys which are used along with other operation keys 15 for executing predetermined functions, a Windows™ key for displaying a start menu of Windows software, a space bar for inserting a space, etc., are arranged in the sixth row, that is, the front row. Cursor keys with which a cursor shown on the display 5 is moved up, down, left, and right are not provided on the keyboard 14.

Some of the operation keys 15 which are disposed near the left end (keys shown by hatching in FIG. 4) serve also as auxiliary input keys 15a for inputting characters when an auxiliary-input software program, which will be described below, is activated. When the auxiliary-input software program is activated, the letter “a” can be input by pressing the auxiliary input key 15a for “ABC” once and the letter “b” can be input by pressing the auxiliary input key 15a for “ABC” twice.

A pointing device 16 is arranged on the top surface 3a of the main unit 3 at the back right corner thereof. When a force is applied to the pointing device 16 in a desired direction with a finger, a pointer shown on the display 5 moves in a direction corresponding to the direction in which the force is applied.

In addition, four cursor keys 17 are arranged along the periphery of the pointing device 16 with constant intervals therebetween. The cursor shown on the display 5 can be moved up, down, left and right by operating the cursor keys 17.

An arc-shaped switching button 18 and a common button 19 for auxiliary input are disposed along the periphery of the cursor keys 17. The switching button 18 is used for changing the orientation and resolution of the display screen and the common button 19 is used for activating a software program (hereinafter called an “auxiliary-input software program”) for inputting characters with a simple operation. In addition to the function as an activation button for activating the software program, the common button 19 also has a function as a selection button with which an item is selected from among items shown on the display 5 when the software program is activated.

In the information processing apparatus 1, the display screen shown on the display 5 can be rotated by 90° or magnified by operating the switching button 18.

A left button 20, a right button 21, and a center button 22 which correspond to right, left, and middle buttons, respectively, of a typical mouse are arranged on the top surface 3a of the main unit 3 at the back left corner thereof. The left button 20 and the right button 21 are arc-shaped and are arranged so as to surround the center button 22. The left button 20 and the right button 21 serve as a first function button and a second function button, respectively, which are used for controlling an object selected by the pointer shown on the display 5. The center button 22 serves as a third function button which enables scrolling of the display screen shown on the display 5.

In the information processing apparatus 1, the left button 20 is larger than the right button 21. Generally, the left button 20 is used more frequently than the right button 21 and is designed to be larger than the right button 21 to improve the operability.

A power button 23, a standby button 24, and a brightness-adjustment button 25 are placed on the left of the switching button 18 and the common button 19 in the back area of the top surface 3a of the main unit 3 with intervals therebetween. The power button 23 is used for turning the power on and the standby button 24 is used for switching between a power-save operation mode and a normal operation mode. The brightness-adjustment button 25 is used for controlling a backlight of the display 5.

A speaker 26 is provided on the left of the power button 23 in the back area of the top surface 3a of the main unit 3.

As shown in FIGS. 1 and 2, air inlets 27 are arranged horizontally in the front side 3b of the main unit 3 at positions near the left end. In addition, as shown in FIG. 3, air outlets 28 are arranged horizontally in the back side 3c of the main unit 3 when the main unit 3 at positions near the left end when viewed from the back.

When the information processing apparatus 1 is used, external air is drawn into the main unit 3 through the air inlets 27 to cool the inside of the main unit 3, and is then exhausted out through the air outlets 28.

When the information processing apparatus 1 is used, the display unit 2 is opened at a suitable angle with respect to the main unit 3, as shown in FIGS. 1, 5, and 6. When the display unit 2 is opened at a suitable angle with respect to the main unit 3, the information processing apparatus 1 can be used as a stationary or portable device.

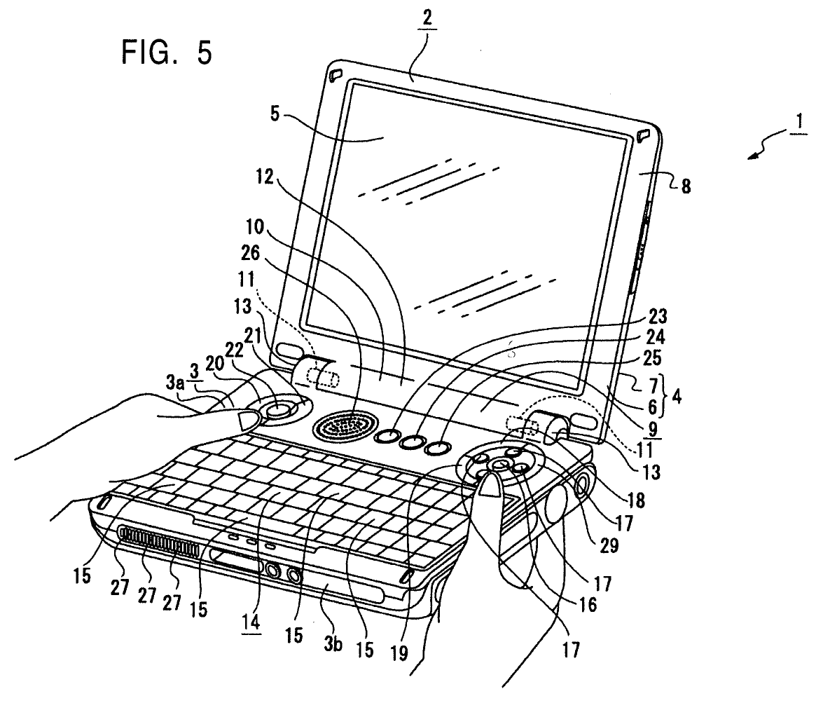

When the information processing apparatus 1 is used as a portable device, the user may operate the information processing apparatus 1 while grabbing the main unit 3 with both hands at the left and right edges thereof, as shown in FIG. 5.

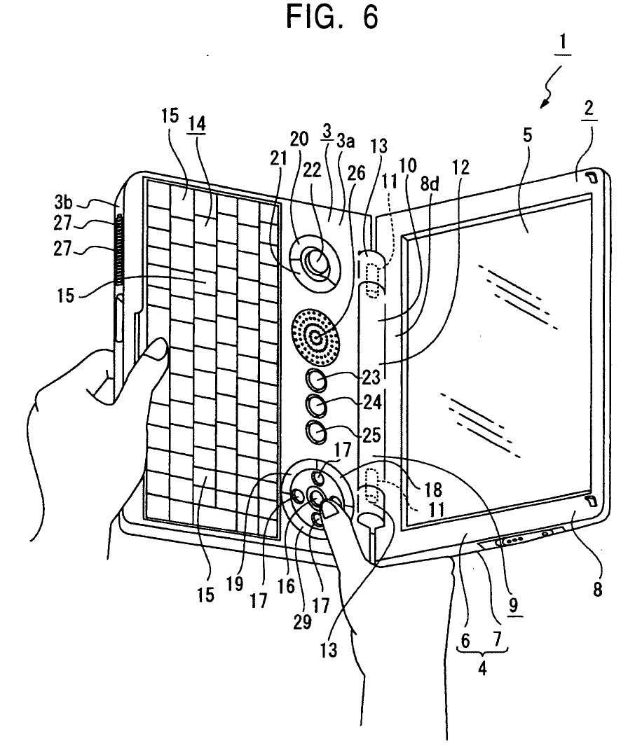

As described above, in the information processing apparatus 1, the display screen can be rotated by 90° by operating the switching button 18. Accordingly, when the information processing apparatus 1 is used as a portable device, the user may also operate the information processing apparatus 1 in an orientation such that, for example, the main unit 3 is on the left and the display unit 2 is on the right, as shown in FIG. 6.

Since the air outlets 28 are formed in the back side 3c of the main unit 3, the exhaust air can be prevented from being output toward the hands or fingers of the user and the operability of the information processing apparatus 1 can be ensured. In addition, since the air inlets 27 and the air outlets 28 are formed in the front side 3b and the back side 3c, respectively, of the main unit 3, the air inlets 27 and the air outlets 28 can be prevented from being covered by the hands of the user when the information processing apparatus 1 is used as a portable device and sufficient cooling effect can be obtained. In addition, since the air outlets 28 are not formed in the front side 3b of the main unit 3, the exhaust air can be prevented from being output toward the user and the operability of the information processing apparatus 1 can be ensured.

Next, main functions of the above-described buttons will be described.

As described above, when a force is applied to the pointing device 16 in a desired direction with a finger, the pointer shown on the display 5 moves in a direction corresponding to the direction in which the force is applied. The moving speed of the pointer can be adjusted by adjusting the amount of force applied to the pointing device 16. In addition, when the left button 20 is pressed (clicked) once, a software program or an item in a menu indicated by the pointer is selected. When the left button 20 is quickly pressed (clicked) twice, a software program or an item in a menu indicated by the pointer is activated (executed).

The cursor shown on the display 5 can be moved up, down, left, and right by operating the cursor keys 17.

As described above, the pointing device 16 and the cursor keys 17 serve important functions in the operation of the information processing apparatus 1, and are frequently used. Therefore, the pointing device 16 and the cursor keys 17 are often used one after the other.

Since the pointing device 16 and the cursor keys 17 are positioned near each other in the information processing apparatus 1, they can be operated without moving a hand each time they are used. Thus, the operability can be improved.

In particular, when the information processing apparatus 1 is used as a portable device as shown in FIGS. 5 and 6, the user can operate the pointing device 16 and the cursor keys 17 while grabbing the main unit 3 with both hands. Thus, the user-friendliness can be improved.

In addition, since the cursor keys 17 are arranged at positions separated from the keyboard 14, the area of the keyboard 14 can be increased accordingly. Therefore, the size of each operation key 15 provided on the keyboard 14 can be increased and the operability of the operation keys 15 can thus be improved.

In addition, since the cursor keys 17 are arranged along the periphery of the pointing device 16 such that the pointing device 16 is at the center of the cursor keys 17, the cursor keys 17 can be positioned in correspondence with the directions in which the cursor is moved. More specifically, the cursor keys 17 for moving the cursor up and down are positioned in front of and behind the pointing device 16 and the cursor keys 17 for moving the cursor left and right are positioned on the left and right of the pointing device 16.

Since the cursor keys 17 are positioned in correspondence with the directions in which the cursor is moved, misoperation can be prevented and the operability can be improved.

In addition, in the information processing apparatus 1, the pointing device 16 and the cursor keys 17 are arranged on the top surface 3a of the main unit 3 at the back right corner thereof. Therefore, when the information processing apparatus 1 is used as a portable device, the pointing device 16 and the cursor keys 17 can be operated by the right hand while grabbing the main unit 3 with the right hand. Thus, the user-friendliness of the information processing apparatus 1 when it is used as a portable device can be improved.

In addition to the switching button 18 and the common button 19 which are arranged at the periphery of the cursor keys 17, the information processing apparatus 1 may also have a confirmation button (enter key) 29 at the periphery of the cursor keys 17, as shown in FIGS. 1, 4, 5, and 6.

The confirmation button 29 is frequently used for confirming and executing an item selected by the pointing device 16 or the cursor keys 17. Therefore, when the confirmation button 29 is arranged at the periphery of the cursor keys 17, the operability and the user-friendliness can be further improved.

The auxiliary-input software program is activated by operating the common button 19. The auxiliary-input software program has a predictive text input function, and shows candidate words for an input character on the display 5.

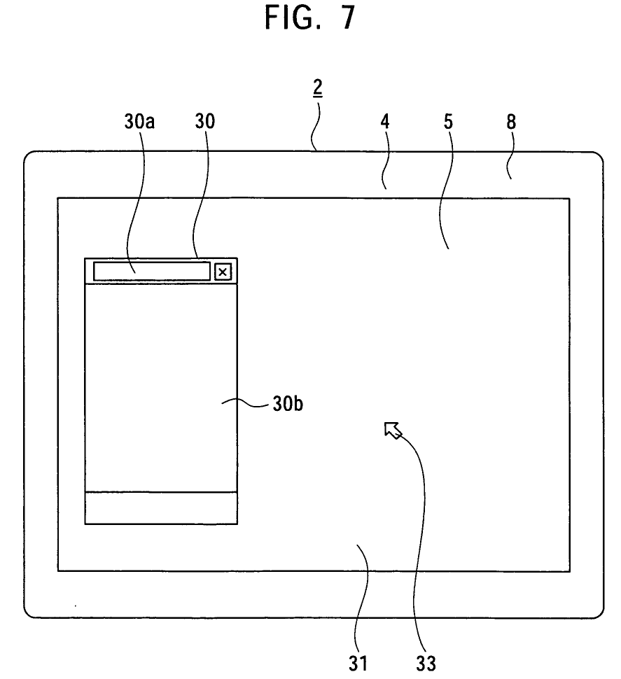

Next, an auxiliary input process using the auxiliary-input software program will be described below with reference to FIGS. 7 to 15.

When the common button 19 is pressed, the auxiliary-input software program is activated and an input screen 30 appears on the display 5, as shown in FIG. 7. The input screen 30 includes an input-character display section 30a and a candidate-word display section 30b.

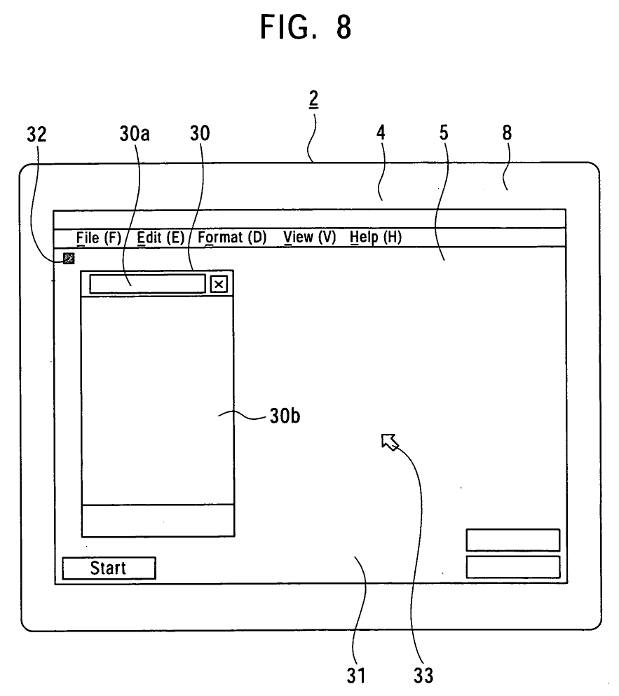

Next, a software program such as a word processor used for inputting text is activated and a cursor 32 is moved to a desired input position in a text input screen 31 of the activated software program, as shown in FIG. 8. The cursor 32 is moved by operating the cursor keys 17 or moving a pointer 33 with the pointing device 16.

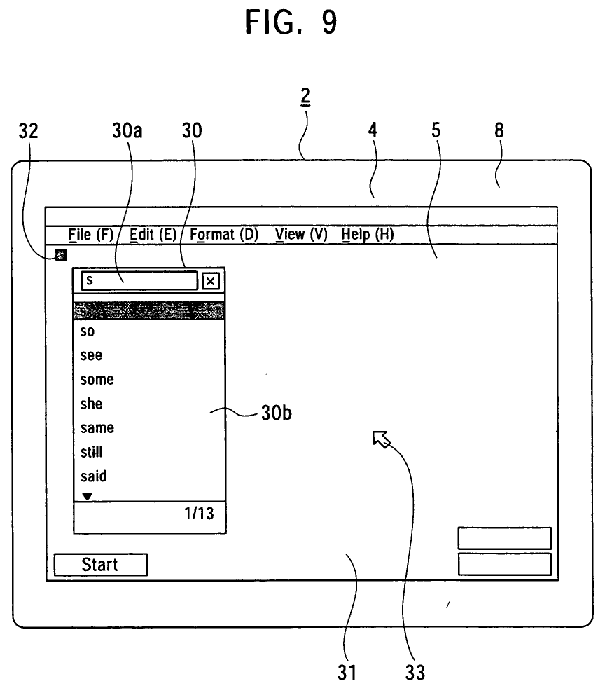

When, for example, “subject of meeting” is to be input, the auxiliary input key 15a for “PQRS” is pressed four times. When the auxiliary input key 15a for “PQRS” is pressed four times, the letter “s” appears in the input-character display section 30a and a list of candidate words which begin with “s” appears in the candidate-word display section 30b, as shown in FIG. 9.

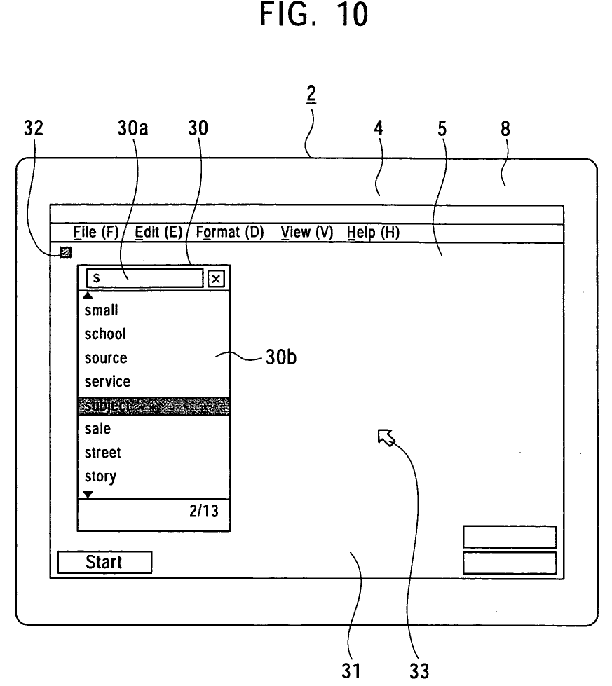

Next, the word “subject” is searched for and selected from among the candidate words listed in the candidate-word display section 30b. The word “subject” is searched for by pressing the down cursor key 17 repeatedly until the word appears in the candidate-word display section 30b, as shown in FIG. 10.

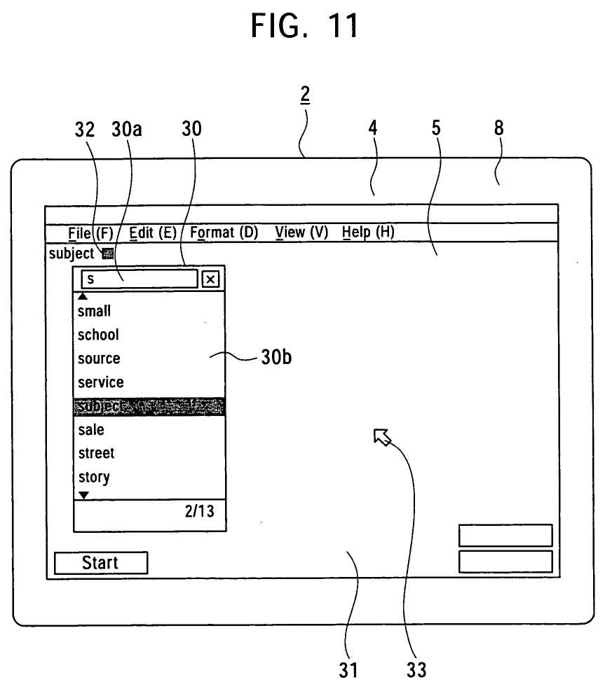

When the word “subject” appears in the candidate-word display section 30b, the common button 19 is pressed while the word “subject” is selected. Thus, “subject” is confirmed to be input and is typed into the text input screen 31 of the activated software program at the position of the cursor 32, as shown in FIG. 11.

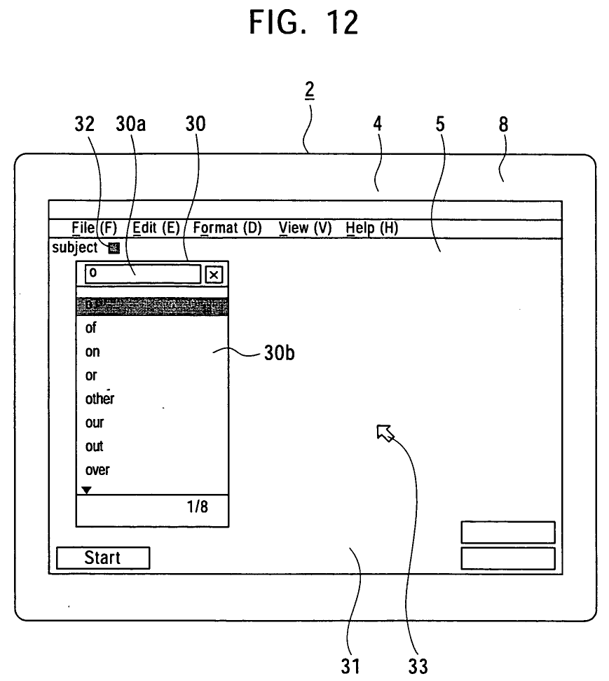

Next, the auxiliary input key 15a for “MNO” is pressed three times. When the auxiliary input key 15a for “MNO” is pressed three times, the letter “o” appears in the input-character display section 30a and a list of candidate words which begin with “o” appears in the candidate-word display section 30b, as shown in FIG. 12.

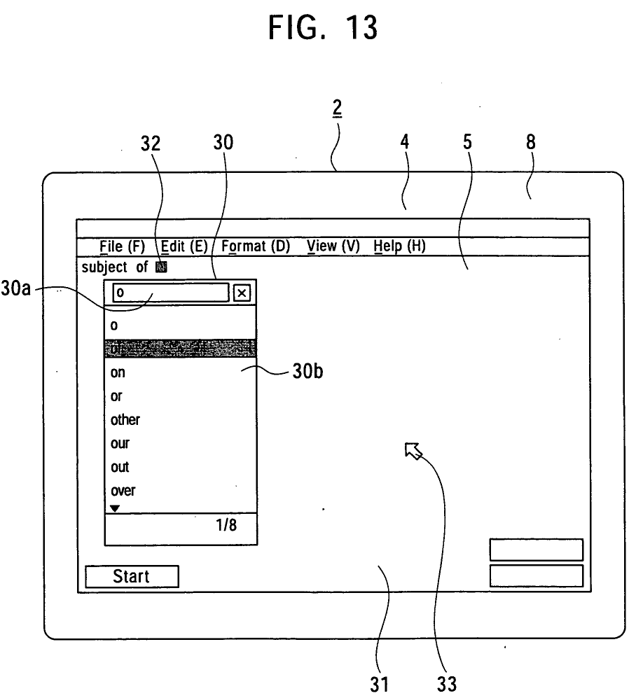

Then, the word “of” is selected and is confirmed to be input by pressing the common button 19. Accordingly, the word “of” is typed into the text input screen 31 at the position of the cursor 32, and “subject of” appears in the text input screen 31, as shown in FIG. 13.

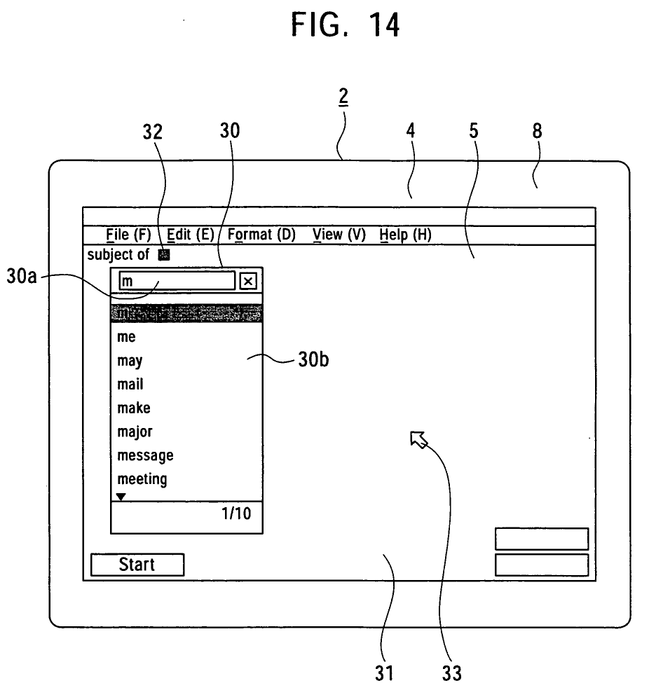

Next, the auxiliary input key 15a for “MNO” is pressed once, so that the letter “m” appears in the input-character display section 30a and a list of candidate words which begin with “m” appears in the candidate-word display section 30b, as shown in FIG. 14.

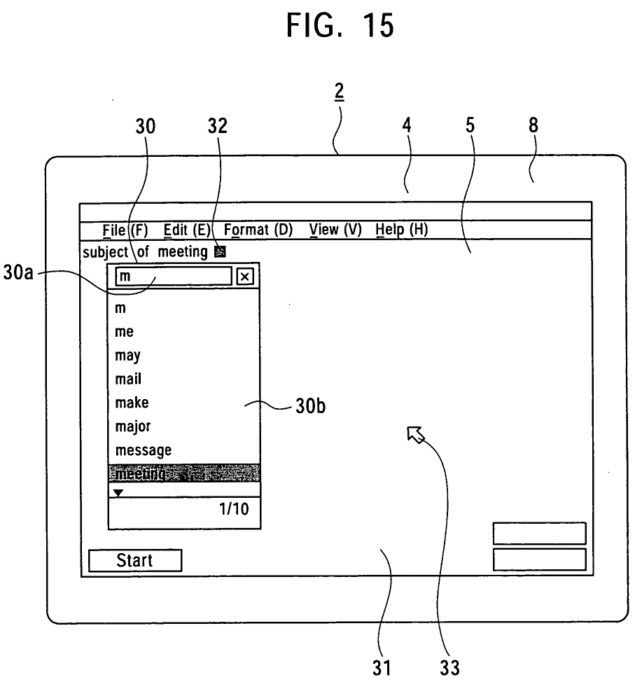

Then, the word “meeting” is searched for and selected from among the candidate words listed in the candidate-word display section 30b. The word “meeting” is searched for by pressing the down cursor key 17 repeatedly until the word appears in the candidate-word display section 30b, as shown in FIG. 15.

When the word “meeting” appears in the candidate-word display section 30b, the common button 19 is pressed while the word “meeting” is selected. Thus, “meeting” is confirmed to be input and is typed into the text input screen 31 at the position of the cursor 32, and “subject of meeting” appears in the text input screen 31, as shown in FIG. 15.

In this manner, “subject of meeting” is typed into the text input screen 31 and the auxiliary input process is finished.

As described above, the information processing apparatus 1 includes the common button 19 used for activating the auxiliary-input software program and confirming an item selected by the cursor keys 17. Thus, different operations regarding the auxiliary-input software program can be performed with a single button. Accordingly, the number of buttons can be reduced without reducing the number of functions and the operability can be improved.

In addition, since the cursor keys 17 used for selecting an item and the common button 19 are placed near each other, the user can perform different operations regarding the auxiliary-input software program without moving a hand. Thus, the operability can be improved.

In particular, when the information processing apparatus 1 is used as a portable device as shown in FIGS. 5 and 6, the user can operate the common button 19 and the cursor keys 17 while grabbing the main unit 3 with both hands. Thus, the user-friendliness can be improved.

In addition, since the pointing device 16 and the common button 19 used in the auxiliary-input software program are placed near each other, the operability and the user-friendliness can be further improved.

In addition, in the information processing apparatus 1, since the cursor keys 17 are arranged along the periphery of the pointing device 16 such that the pointing device 16 is at the center of the cursor keys 17 and the common button 19 is placed at the periphery of the cursor keys 17, the space of the main unit 3 is used efficiently. Accordingly, the size of the information processing apparatus 1 can be reduced.

A software program or an item in a menu indicated by, for example, the pointer can be selected by pressing the left button 20 once, and the software program or the item in the menu indicated by the pointer can be activated (executed) by quickly pressing the left button 20 twice. The selection of the software program or the item in the menu achieved by pressing the left button 20 once and the activation (execution) thereof achieved by pressing the left button 20 twice can also be achieved by pressing (clicking) the pointing device 16 once or twice.

A sub menu (pop-up menu) including various items can also be displayed at the position of the cursor by pressing the right button 21. Selection from among the items in the sub menu can be achieved by operating the pointing device 16 or the cursor keys 17, and execution of the selected item can be achieved by operating the left button 20, the pointing device 16, the enter key on the keyboard 14, or the confirmation button 29.

In addition, an object, for example, an icon shown on the display 5 can be moved to an desired position on the display 5 by placing the pointer on the object and applying a force to the pointing device 16 in a desired direction while pressing the left button 20.

In addition, the display screen can be scrolled in predetermined directions by applying a force to the pointing device 16 in the predetermined directions while pressing the center button 22. For example, the display screen can be scrolled sideways by operating the pointing device 16 to the left and right while pressing the center button 22, and the display screen can be scrolled up and down by operating the pointing device 16 up and down while pressing the center button 22.

In addition, in the information processing apparatus 1, the display screen can be scrolled up and down continuously after it is scrolled sideways by operating the pointing device 16 to the left and right without and then up and down removing the finger from the pointing device 16 while continuously pressing the center button 22. Similarly, the display screen can be scrolled sideways continuously after it is scrolled up and down by operating the pointing device 16 up and down and then to the left and right without removing the finger from the pointing device 16 while continuously pressing the center button 22.

In the above-described case, the display screen is scrolled by operating the pointing device 16 while pressing the center button 22. However, the center button 22 may also be constructed such that the display screen can be scrolled by applying a force to the center button 22 in a desired direction without using the pointing device 16.

In the information processing apparatus 1, the left button 20, the right button 21, and the center button 22 are arranged on the top surface 3a of the main unit 3 at the back left corner thereof. Therefore, when the information processing apparatus 1 is used as a portable device, the left button 20, the right button 21, and the center button 22 can be operated by the left hand while grabbing the main unit 3 with the right hand. Thus, the user-friendliness of the information processing apparatus 1 when it is used as a portable device can be improved.

In particular, the left button 20, the right button 21, and the center button 22 are frequently used and are often used one after another. Since they are positioned near each other, different operations can be performed without moving a hand and the operability can be improved.

In addition, since the left button 20 and the right button 21 are at the periphery of the center button 22, the space of the main unit 3 is used efficiently. Accordingly, the size of the information processing apparatus 1 can be reduced.

In addition, the pointing device 16 and the cursor keys 17, which are used frequently, are positioned near the right end of the main unit 3 and the left button 20, the right button 21, and the center button 22 are positioned near the left end of the main unit 3. Therefore, when the information processing apparatus 1 is used as a portable device, the left button 20, the right button 21, and the display unit 2 can be operated by the left hand while grabbing the main unit 3 with the left hand and the pointing device 16 and the cursor keys 17 can be operated by the right hand while grabbing the main unit 3 the right hand, as shown in FIG. 5. Thus, the user-friendliness can be improved.

In the above-described case, the center button 22 is used for scrolling the display screen. However, the center button 22 may also be set so as to serve functions similar to those of the left button 20 and the right button 21.

In addition, the center button 22 may also be set such that the cursor can be moved one page back or forward by operating the cursor keys 17 while pressing the center button 22.

In addition, in the above-described case, the pointing device 16, the cursor keys 17, the switching button 18, the common button 19, and the confirmation button 29 are placed near the right end of the main unit 3 and the left button 20, the right button 21, and the center button 22 are placed near the left end of the main unit 3. However, the arrangement may also be such that the left button 20, the right button 21, and the center button 22 are placed near the right end of the main unit 3 and the pointing device 16, the cursor keys 17, the switching button 18, the common button 19, and the confirmation button 29 are placed near the left end of the main unit 3.

In the above-described embodiment, the shape and construction of each component are described merely for illustrating an example in which the present invention is applied, and the scope of the present invention is not limited to the above-described embodiment.

What is claimed is:

1. An information processing apparatus comprising:
a display;
a pointing device for moving a pointer appearing on the display in a desired direction; and
a plurality of cursor keys for moving a cursor appearing on the display in predetermined directions, the cursor keys being arranged near the pointing device.

2. An information processing apparatus according to claim 1, wherein the cursor keys are arranged along the periphery of the pointing device such that the pointing device is at the center of the cursor keys.

3. An information processing apparatus according to claim 1, further comprising:
a display unit having a display housing on which the display is provided;
a main unit provided with a keyboard having a plurality of operation keys; and
a hinge unit which connects the display unit and the main unit such that the display unit can pivot to open and close the keyboard,
wherein the hinge unit includes a hinge barrel and hinge pins disposed in the hinge barrel, and
wherein the pointing device and the cursor keys are positioned near one end of the information processing apparatus along the axis of the hinge pins in an area between the display unit and the keyboard.

4. An information processing apparatus according to claim 1, further comprising a confirmation button for confirming a selected or input item, the confirmation button being positioned near the pointing device or the cursor keys.
